(19) United States
(12) Patent Application Publication
(10) Pub. No.: US 2010/0041000 A1
(43) Pub. Date: Feb. 18, 2010

(54) System and Method for Controlling the Presentation of Material and Operation of External Devices

(76) Inventors: Andrew B. Glass, Dix Hills, NY (US); Henry Van Styn, Cincinnati, OH (US); Coleman Kane, El Paso, TX (US)

Correspondence Address: FROST BROWN TODD, LLC, 2200 PNC CENTER, 201 E. FIFTH STREET, CINCINNATI, OH, 45202, US

(21) Appl. No.: 12/388,785

(22) Filed: Feb. 19, 2009

Related U.S. Application Data
(60) Provisional application No. 61/031,508, filed on Feb. 26, 2008.

(51) Int. Cl. G09B 17/04; G09B 19/04

(52) U.S. Cl. 434/179; 434/185

(57) ABSTRACT

By performing a comparison of words spoken by a speaker and defined material which is presented to the speaker, information can be determined which allows for the convenient control of the presentation of material and external devices. A comparison of a speaker's words with defined material can be beneficially used as an input for controlling the operation of an exercise apparatus, video games, material presented to an audience, and the presentation of the material itself. Similar feedback loops can also be used with measurement and stimulation of neurophysiologic states, to make the activity of reading more enjoyable and convenient, or for other purposes.

### CROSS REFERENCE TO RELATED APPLICATIONS

This application claims priority from U.S. patent application Ser. No. 11/686,609, filed Mar. 15, 2007, which claims priority from Provisional Application Ser. No. 60/743,489, filed March 15, 2006. This application also claims priority from Provisional Application Serial No. 61/031,508, filed Feb. 26, 2008. The disclosures of each of the above identified documents are hereby incorporated by reference.

### BACKGROUND OF THE INVENTION

Two activities which have been shown to have a significant positive effect on mental health and brain stimulation are exercise and reading aloud. At present, many individuals combine reading with exercise by placing reading material, such as a magazine, on an exercise machine and reading it during their workout. However, this method of combining reading with exercises is suboptimal for a number of reasons. First, while many individuals read during exercise, few actually read aloud during exercise, thus forfeiting the unique benefits associated with reading aloud. Second, the reading material is not connected in any way to the exercise, which means that benefits which can be obtained by modulating the presentation of reading material based on the exercise program or the exerciser's physiologic responses are lost. Third, because the exercise is not connected in any way to the reading material, benefits which can be obtained by modulating the exercise based on reading performance are also lost. Fourth, manipulation of the reading material (e.g., keeping material steady, turning pages, locating a specific article) can be cumbersome, unsafe, or even impossible depending on the exercise being done, because manipulating the reading material might require the use of the exerciser's hands, or might require the exerciser to shift his or her balance in a manner which is incompatible with continuing exercise. Thus, there is at present a need for an invention which allows an individual to read aloud while exercising which can remedy one or more of the deficiencies currently associated with reading during an exercise program. Outside of the specific context of exercise, speech recognition technology is often used for the purposes of converting spoken words to text, or to automate specific verbal commands. However, there are substantial benefits which could be accrued by expanding the functionality of speech recognition technology. For example, by allowing the presentation of material to be controlled by the rate of an individual's speech, speech recognition technology could facilitate the processes of preparing or actually presenting oral lectures. Currently, oral lectures are often given with the aid of presentation software which may present a great array of material in addition to the spoken text which is primarily for an audience, but also acts to prompt the presenter; or of a teleprompter which is limited to displaying the text to be delivered. In either case, the rate of material presentation is generally controlled by a human who attempts to match the material flow to the speaker's progress, or by the speaker himself or herself through manual control, or by simply maintaining a constant rate of material presentation. Each of these methods has drawbacks, such as cost, inflexibility, and/or burdening the speaker. Further, incorporating speech recognition technology for the purpose of allowing the material to be controlled by verbal commands would detract from the presentation by requiring the speaker to give commands such as “forward” during the speech. Thus, there is substantial need for an innovation which utilizes measures of spoken language, such as the rate or accuracy of speech to control external systems or the presentation of information. Further, while speech recognition technology is making continual strides in terms of transcription and analysis of spoken language, present technology is unable to provide complete accuracy of either transcription or analysis. Thus, there is a need for applications which are able to achieve functionality which is not dependent on accurate performance by speech recognition software.

### BRIEF DESCRIPTION OF THE DRAWINGS

FIG. 1 depicts illustrative data flows in a system in which operation of an exercise apparatus can be controlled by a user's speech alone or in combination with other data.

FIGS. 2 and 2a depict systems in which a user's speech is used for the purpose of controlling information displayed during a presentation.

FIGS. 3 and 3a depict systems in which a user's speech is used for the purpose of training voice recognition software.

FIG. 4 depicts a system in which a user's speech can be used for purposes such as stimulating a desired neurophysiologic state, and/or diagnosing and evaluating a neurophysiologic state of the user.

FIG. 5 depicts a system which can be used for facilitating the activity of reading aloud by individuals for whom it may be inconvenient or impossible to manually actuate reading material.

### SUMMARY OF THE INVENTION

Portions of the teachings of this disclosure could be used to implement a system comprising an exercise apparatus, a microphone positioned so as to be operable to detect speech by a user of the exercise apparatus, a display positioned so as to be visible to the user of the exercise apparatus and operable to display material from a defined source, a natural language comparator operable to compare speech detected by the microphone with material from the defined source, and a rate optimizer operable to determine a set of data comprising one or more rates based at least in part on an output from the natural language comparator. In some such systems, the set of data determined by the rate optimizer is used to control the exercise apparatus.

Due to technology specific meanings which should be ascribed to certain terms and phrases used in this disclosure, the system description set forth in the previous paragraph should be understood in light of the explanation set forth below. The term “material” should be understood to refer to any content which is represented in the form of words, syllables, letters, symbols (e.g., punctuation) and/or numbers, or which is, or can be, coordinated with content which is so represented. Examples of “material” include: text, pictures, illustrations, animations, application files, multimedia content, sounds, tactile, haptic and olfactory stimuli. Further examples of “material” are provided in this disclosure, though all such examples are provided for the purpose of illustration only, and should not be treated as limiting on the scope of “material” or of claims which are included in, or claim the benefit of, this disclosure. Further, a “defined source” of “material” should be understood refer to an identifiable logical or physical location from which “material” can be obtained. Examples of such “defined sources” include files stored in computer memory, data ports which can transmit material from remote servers or storage devices, and drives which can store material for later retrieval. Further examples are provided in this disclosure, though all such examples are provided for the sake of illustration only, and should not be treated as limiting on the scope of claims which are included in, or claim the benefit of, this application. Another term which should be understood to have a particular meaning is the verb “determine” (and various forms of that verb). For the purpose of this disclosure, the verb “determine” should be understood to refer to the act of generating, selecting or otherwise specifying something. For example, to obtain an output as the result of analysis would be an example of “determining” that output. As a second example, to choose a response from a list of possible responses would be a method of “determining” a response. The term “natural language comparator” should be understood to refer a device which is capable of comparing two sources of natural language data (where natural language data is data representing language understandable to a human, such as French, English or Japanese, rather than machine language such as ×86 and EPIC assembly) and deriving one or more outputs based on that comparison. A “natural language comparator” should not be limited to a specific implementation, and should instead be understood to encompass all manner of natural language comparators, including those which are encoded as logical instructions (whether in software, hardware, firmware, or in some other manner) which are performed by or embedded in another machine. Similarly, a “rate optimizer” should be understood to refer to a device which is capable of determining a ratio between two or more quantities (e.g., steps per minute, syllables per heartbeat, degrees of declination per page per minute, etc.) which has or approximates one or more desirable characteristics (e.g., a rate of material presentation in paragraphs/minute which can be read accurately by an individual running at a given speed; a rate of activity for an exercise apparatus which provides a maximum sustained heart rate without decreasing reading accuracy; etc.) regardless of how implemented, including by logical instructions (whether in software, hardware, firmware, or in some other manner) which are performed by or embedded in another machine. Additionally, the phrase “control the exercise apparatus” should be understood to refer to directing the one or more aspects of the operation the exercise apparatus, for example, in the case of a treadmill, by specifying the rate of incline and/or the rate of motion for the treadmill. It should be understood that controlling the exercise apparatus is not limited to controlling aspects of the exercise apparatus which determine the user's exertion. For example, if an exercise apparatus has a built in (i.e., incorporated) or integrated display, controlling the display (e.g., to present material to the user of the exercise apparatus) would be controlling the exercise apparatus, because operation of the display itself would be an aspect of the operation of the exercise apparatus. Additionally, in the context of this disclosure, a “display control component” should be understood to refer to a device, or an aspect of some other device, which is designed and implemented to control the presentation of material to a user, preferably on a display. It should be understood that a “display control component” might be used with a larger system through a variety of techniques, for example, by connection to the larger system through data ports (e.g., USB ports), or, in the case of a “display control component” which is implemented as logical instructions, by incorporation of logical instructions defining the display control component into a device (e.g., as software) as a dedicated module, or as a part of some other module which performs one or more additional functions.

By way of further explanation, in some systems as described above in which a set of data is used to control the operation of an exercise apparatus, the set of data is also used to control the display of material from the defined source. In some such systems, the display of material could be further controlled by text presentation format instructions. Similarly, in some systems, controlling the display of material from the defined source comprises determining whether the material should be paged forward on the display. Additionally, some systems which include an exercise apparatus, a natural language comparator, and a rate optimizer might be augmented or supplemented with a physiology monitor, in which case an output of the physiology monitor might be used by the rate optimizer in conjunction with the output from the natural language comparator.

For the sake of clarity, certain portions of the above description should be understood to have technology specific meanings. For example, the statement that “the set of data is further used to control the display of material” should be understood to indicate that one or more elements in a set (i.e., a number, group, or combination of one or more things of similar structure, nature, design, function or origin) of data is used to control the exercise apparatus, and one or more elements in the set of data is used to control the display of material. In some instances, the elements used might be different elements (e.g., a derived material presentation rate might be used to control the display of material, while an observed accuracy rate might be used to control the incline on a treadmill), or they might be the same element (e.g., both the display of material and the speed of the treadmill could be controlled by a determination of what portion of the material presented to the user has just been read). Similarly, “text presentation format instructions” should be understood to refer to instructions which specify how material (including, but not limited to, text) should be presented. For example, “text presentation format instructions” might specify an optimal word or line spacing, a font size, where certain elements of the material (e.g., words, syllables, paragraphs, illustrations, etc) should presented on the display, and/or a zoom or magnification level for the material. Additionally, it should be understood that “text presentation format instructions” are not limited to static or predefined instructions, but might also include instructions which are dynamically modified to determine the optimal presentation format for a particular user (e.g., the text presentation format instructions might be dynamically modified to specify the greatest number of words per line which can be displayed for a user without negatively affecting the user's material reading rate and/or accuracy). Further examples of “text presentation format instructions” and their uses are set forth herein, though it should be understood that all such examples are intended to be illustrative only, and should not be used to limit the scope of the claims included in this application, or any claims which claim the benefit of this application. Also, in the context of this disclosure, “paging forward” should be understood to refer to the act of advancing material in a discontinuous manner, as in turning the page of a book, as opposed to by substantially continuously advancing material as by scrolling. It should be understood that paging forward could be accompanied by graphics (e.g., a page turning, or material advancing) which could be used to help prevent a reader from becoming disoriented from the discontinuous advance of material. Further, in the context of this disclosure a “physiological state” should be understood to refer to some aspect of the processes or actions of a living organism. Thus, examples of physiological states include heart rate, heart rate variability, brain blood flow, brain waves, respiration rate, oxygen consumption, blood chemistry markers or levels (e.g., endorphin levels), and other aspects of a person's physical condition (and their combinations, to the extent appropriate for a given application).

By way of further explanation of data which might be used in a system comprising an exercise apparatus and a natural language comparator, in some embodiments, the output of the natural language comparator might comprise two numerical measurements taken from the list consisting of: material reading accuracy; material reading rate; and, current material location. Additionally, if a system is implemented to control an exercise apparatus, that control might comprise determining a parameter which defines a workout for the user of the exercise apparatus. For the sake of understanding, in the technical context of this disclosure, a “parameter which defines a workout” should be understood to refer to one or more quantities which can be used to describe the operation of an exercise apparatus used by a user (e.g., resistance, incline, rate, duration, and others as appropriate for specific apparatuses).

It should be understood that, while some aspects of this disclosure can be implemented in systems as described above, neither this disclosure, nor the claims which are included in or claim the benefit of this application is limited to systems as described previously. For example, in light of this disclosure, one of skill in the art could also implement an apparatus comprising: a natural language comparator operable to derive a plurality of measurements regarding a user's speech input based on a comparison of the user's speech input with a text string obtained from a defined material source; a display control component operable to determine an image for presentation on a display based on one or more of the measurements derived by the natural language comparator; and, a metric storage system operable to store a set of performance data based on the user's speech input.

For the sake of clarity, the phrase “text string” should be understood to refer to a series of characters, regardless of length. Thus, both the play Hamlet, and the phrase “to be or not to be” are examples of “text strings.” Similarly, the phrase “a set of performance data” should be understood to refer to a set of data (that is, information which is represented in a form which is capable of being processed, stored and/or transmitted) which reflects the manner (including the accuracy, speed, efficiency, and other reflection's of expertise or ability) in which a given task is accomplished or undertaken. Examples of performance data which could be included in the “set of performance data based on the user's speech input” might include the speed at which the user was able to read a particular passage, the accuracy with which a user read a passage, the thoroughness with which a user reads a particular passage (e.g., whether the user read all words, or skipped one or more section of the passage), and a score representing the user's overall ability to read a specified passage. Additional examples are presented in the course of this disclosure. It should be understood that all such examples are presented as illustrative only, and should not be treated as limiting on the scope of the claims included in this application or on claims included in any application claiming the benefit of this disclosure. Another phrase which should be understood as having a meaning specific to the technology of this disclosure is “metric storage system”, which should be understood to refer to devices or instructions which are capable of causing one or more measurements (metrics) to be maintained in a retrievable form (e.g., as data stored in memory used by a computer processor) for some (potentially unspecified) period of time. Also, an indication that a “display control component” is operable to “determine an image for presentation on a display” should be understood to mean that the display control component is operable to select, create, retrieve, or otherwise obtain an image or data necessary to represent an image which will then be presented on the display. For example, a display control component might perform calculations such as shading, ray-tracing, and texture mapping to determine an image which should be presented. Another example of a display control component determining an image is for a display control component to retrieve predefined text and image information and combine that information according to some set of instructions (e.g., markup language data, text presentation format instructions, template data, or other data as appropriate to a specific implementation). Additional examples of images presented on a display, and discussion of how those images might be determined is set forth herein. Of course, all such examples and discussion should be understood as being illustrative only, and not limiting on the scope of the claims included in, or claiming the benefit of, this application.

In some apparatuses as described above, the defined material source might comprise a set of narrative data which is organized into a plurality of levels; and the presentation of narrative data corresponding to a first level might be conditioned on a measurement from the set of performance data reaching a predefined threshold. Additionally, in such an apparatus, the predefined material source might be stored on a first computer readable medium and the metric storage system, the display control component, and the natural language comparator might be encoded as instructions stored on a second computer readable medium.

For the sake of clarity, certain aspects of the above description should be understood as having specific meanings. First, “narrative data” should be understood as referring to data which represents or is structured according to a series of acts or a course of events. Examples of “narrative data” include data in which a series of event is set forth literally (e.g., an epic poem such as Beowulf), as well as data which controls a story defined in whole or in part by a user (e.g., instructions for a computer game in which the particular acts or events which take place are conditioned on actions of the user). Second, the term “level” should be understood to refer to a particular logical position on a scale measured by multiple such logical positions. For example, in the context of presentation of material a “level” can refer to a level of difficulty for the narrative material (e.g., a story could be presented at a first grade level could have simpler vocabulary and sentence structure than if the story is presented at a sixth grade level). As another example, a “level” might comprise a portion of the narrative material which is temporally situated after some other portion (e.g., a narrative might be organized according events which take place in the morning, events which take place during the day, and events which take place during the night). When presentation of narrative data corresponding to a level is conditioned upon a measurement reaching a predefined threshold, the narrative data will only be presented to the user when some goal has been met. For example, some portion of a piece of narrative data might only be presented when a measurement of the material already read by the user reaches some predefined point. Alternatively, the user might be presented with material corresponding to a new level when the user is able to read a particular passage with a certain material reading rate and/or accuracy. Of course, all such examples, as well as additional examples of the application of this concept which are discussed herein are intended to be illustrative only, and should not be treated as limiting on the scope of claims included in this application or which may claim the benefit of this application.

Additionally, the concept of a “computer readable medium” and the relationship of such a medium to certain types of apparatuses which could be implemented according to this disclosure should be understood in the context of this disclosure as follows. First, a “computer readable medium” should be understood to refer to any object, substance, or combination of objects or substances, capable of storing data or instructions in a form in which they can be retrieved and/or processed by a device. A “computer readable medium” should not be limited to any particular type or organization, and should be understood to include distributed and decentralized systems however they are physically or logically disposed, as well as storage objects of systems which are located in a defined and/or circumscribed physical and/or logical space. Examples of “computer readable mediums” include (but are not limited to) compact discs, computer game cartridges, a computer's random access memory, flash memory, magnetic tape, and hard drives. An example of an apparatus in which a measurement is stored on a first computer readable medium and a metric storage system, a display control component, and a natural language comparator are stored on a second computer readable medium would be an apparatus comprised of a game console, a memory card, and an optical disc storing instructions for the game itself. The display control component, the natural language comparator and the metric storage system might all be encoded on the optical disc, which would be inserted in to the console to configure it to play the encoded game. The metric storage system might instruct the game console to store measurements regarding speech by the user during the game on the memory card (second computer readable medium). Of course, the claims included in this application, or other claims claiming the benefit of this application should not be limited to that specific configuration, which is set forth for the purpose of illustration only.

As further illustration, in some apparatuses which comprise a metric storage system operable to store a set of performance data, a natural language comparator operable to derive a plurality of measurements regarding a user's speech input based on a comparison of the user's speech input with a text string, and a display control component operable to determine an image for presentation on a display, the performance data might comprise reading accuracy and reading rate, and the image might comprise a portion of the text string. As an example to illustrate an image comprising portion of a text string, consider the case of a image in a computer application which comprises a picture of a speaker and a transcription of the speaker's words. Such an image would comprise a portion of a text string, wherein the text string is the words associated with the speaker.

Additionally, portions of this disclosure could be implemented in an apparatus as described above wherein the apparatus is operable in conjunction with a home video game console. For the sake of clarity, when an apparatus is referred to as being operable in conjunction with a video game console, it should be understood to mean that there is some function which is capable of being performed through the combined use of both the apparatus and the video game console (e.g., by an apparatus being inserted into the console to configure it to play a game, by an apparatus being connected to a video game console through a data port, or by some other form of combined use).

Additionally, in some apparatuses which comprise a natural language comparator, and a display control component, the natural language comparator might be operable to derive information indicating correct reading of a passage presented on a display. In such an apparatus, as a result of the natural language comparator indicating correct reading of the passage, the display control component might determine that a second passage should be presented (i.e., shown or delivered to a target audience or individual) on the display.

Such a second passage which is presented on the display as a result of the correct reading of the first passage might be presented to provide positive reinforcement for the correct reading of the first passage.

For the purpose of clarity, the apparatus description above should be understood as having a meaning which is informed by the technology of this disclosure. First, “correct reading of a passage” should be understood to refer to reading aloud of a passage in a manner which meets some defined requirement. For example, an apparatus could be configured such that, if an individual is able to read a passage in under 60 seconds with greater than 90% accuracy, the reading of the passage will be determined to be “correct.” As another example, in some situations an apparatus could be configured such that, if an individual is able to read a passage with emphasis and pronunciation as indicated in a phonetic key for that passage, the reading will be determined to be “correct.” Such examples, as well as further examples included herein, are set forth for the purpose of illustration only, and should not be treated as limiting. A second phrase which should be understood as having a particular meaning is “positive reinforcement.” As used above, “positive reinforcement” should be understood to refer to a stimulus which is presented as a result of some condition being fulfilled which is intended to increase the incidence of the condition being fulfilled. As an example of a “positive reinforcement” for correctly reading material, if a user reads a passage from a play such as hamlet, upon completion of the passage, the user might be presented with related entertaining material, such as “fun facts,” or a short poem or story.

As an additional demonstration of potential implementations of the teachings of this disclosure, some aspects of this disclosure could be implemented in a system comprising:

a microphone operable to detect spoken words; a natural language comparator operable to generate a set of output data based on a comparison of spoken words detected by the microphone with a set of defined information corresponding to a presentation, wherein the presentation comprises a speech having content and wherein the defined information comprises a semantically determined subset of the content of the speech; and, a display control component operable to cause a portion of the defined information to be presented on a display visible to an individual presenting the speech, and to alter the portion presented on the display based on the set of output data. In some implementations, the semantically determined subset of the content of the speech might consist of a plurality of key points. In an implementation where the semantically determined subset consists of a plurality of key points, altering the portion presented on the display might comprise adding an indication to the display that a key point has been addressed by the individual presenting the speech. Alternatively, or additionally, altering the portion presented on the display might comprise removing a first key point which has already been addressed by the individual presenting the speech from the display, and displaying a second key point which has not been addressed by the individual presenting the speech. In some implementations in which the semantically defined subset of information consists of a plurality of key points, those key points might be compared with the spoken words detected by the microphone using dynamic comparison.

For the purpose of clarity, the above system description should be understood in the context of special meanings relevant to the technology of this disclosure. First, in the context above, a “key point” should be understood to refer to a major idea, important point, or central concept to the content of a presentation. For example, in the context of reporting an appellate court decision, “key points” might include the relationship of the parties (so the target of the report will know who is involved), the disposition of the case at the lower court level (so that the target of the report will know what led to the appeal), and the holding of the appellate court (so the target of the report will know the rule of law going forward). Second, a “semantically determined subset” should be understood to refer to a subset of some whole which is defined based on some meaningful criteria. As an example of such a “semantically determined subset,” if a speaker wishes to give a presentation and communicate three key points to an audience, the three key points would be a “semantically determined subset” of the content of the presentation. It should be noted that, even if the key points do not appear in a transcript of the presentation, they would still be a “semantically determined subset” of the presentation as a whole. To provide further illustration, material outlines, executive summaries, bullet lists, and excerpts could all be used as “semantically determined subsets.” Of course, all such examples are provided for the purpose of illustration only, and should not be treated as limiting on the scope of claims included in this application or which claim the benefit of this disclosure. Third, the verb phrase “to alter the portion presented on the display” should be understood to refer to making some change to a display which presents a portion (which could be some or all) of something else. An example of such an alteration to a display which presents a list of key points for a presentation would be to remove a key point from the display when it has been addressed, and add a new key point which could meaningfully be addressed based on the content presented thus far. Another example would be to add an indication on entries for key points which have been addressed (e.g., by placing a check mark next to the entries, or crossing them out once they are addressed). Of course such techniques could also be combined, or combined with additional techniques described herein, or with other techniques as could be implemented without undue experimentation based on this disclosure. Fourth, the phrase “dynamic comparison” should be understood to refer to a multistep process in which the relationship of two or more things is compared based on characteristics as determined at the time of comparison, rather than based on predefined relationships. To illustrate, an example of dynamic comparison of spoken words and key points would be to analyze the semantic content of the spoken words, and then determining if the content of the words matches one of the key points. For further illustration, a non-example of “dynamic comparison” would be to perform a literal comparison of spoken words and a key point (e.g., as is performed by the strcmp(char*, char*) function used in C and C++ programming). A second non-example would be to define a key point, and define a large set of words which is equivalent to the key point, then, to compare the spoken words with both the key point and the large set of equivalent words. Thus, while both literal comparison, and comparison using equivalence sets could be implemented based on this disclosure, they are not examples of “dynamic comparison.” Of course, the non-examples of dynamic comparison should not be treated as outside the scope of claims which do not recite the limitation of “dynamic comparison” and are included in this application or which claim the benefit of this disclosure.

As an extension of the description above, some systems which could be implemented according to this disclosure which comprise a display control component and a first display which displays a portion of a semantically determined subset of the content of a speech might also comprise a second display. In such systems, the display control component might be further operable to cause a portion of the content of the speech to be presented on the second display, and that portion might comprise a prepared text for the speech. Thus, by way of illustration, a system might be implemented according to this disclosure wherein a display control component causes a first display (e.g., a teleprompter) to display a semantically determined subset of the content of a speech, and also causes a second display (e.g., an audience facing screen) to display a portion of the content of the speech which is a prepared text for the speech (e.g., a script, which might have its presentation coordinated with the delivery of the speech by the presenter). Of course, it is also possible that, rather than presenting a portion of the content of the speech which is a prepared test for the speech, a second the display control component might cause the second display to display material related to the speech, such as one or more images. As a further clarification, it should be noted that, in this application, numeric terms such as “first” and “second” are often used as identifiers, rather than being used to signify sequence. While the specific meaning of any instance of a numeric term should be determined in an individual basis, in the claims section of this application, the terms “first” and “second” should be understood as identifiers, unless their status as having meaning as sequential terms is explicitly established. This illustration, as well as additional illustrations included herein should be understood as being provided as clarification only, and should not be treated as limiting.

Additionally, it should be understood that this disclosure is not limited to being implemented in systems and apparatuses as described above. The inventors contemplate that the teachings of this disclosure could be implemented in a variety of methods, data structures, interfaces, computer readable media, and other forms which might be appropriate to a given situation. Additionally, the discussion above is not intended to be an exhaustive recitation of all potential implementations of this disclosure.

### DETAILED DESCRIPTION

This disclosure discusses certain methods, systems and computer readable media which can be used to coordinate an individual's speech and/or other data with material presentation, the control of external devices, and other uses which shall be described herein or which can be implemented by those of ordinary skill in the art without undue experimentation in light of this disclosure. For the purposes of illustration, several exemplary implementations of systems and methods for coordinating the operation of an external apparatus with the presentation of written material are set forth herein. In some of those exemplary implementations, the term “RAT” and “ReadAloud” are used to describe a system, method or application which incorporates the comparison of spoken words with defined material. For the purpose of clarity “RAT” and “ReadAloud” should be understood to stand for Read Aloud Technology, which should be understood as a modifier descriptive of an application which is capable of comparing a user's speech (either as translated by some other application or library, or as processed by the RAT application itself) with some defined material, and deriving output parameters such as the reader's current material location, material reading accuracy, a presentation rate for the material, and other parameters as may be appropriate for a particular implementation. It should be understood that the exemplary implementations, along with alternate implementations and variations, are set forth herein for the purpose of illustration and should not be treated as limiting. It should also be understood that the inventors contemplate a variety of implementations that are not explicitly described herein.

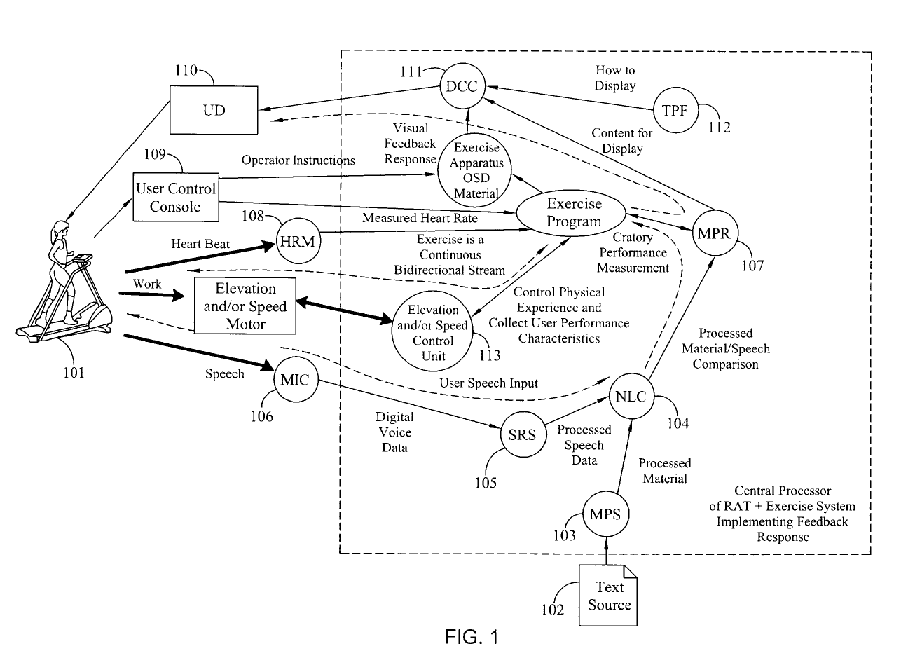

Turning to FIG. 1, that figure depicts illustrative data flows between the components of an exemplary implementation which features coordination of the operation of an exercise apparatus [101] with presentation of content from an external text source [102]. In a system implemented according to FIG. 1, the material from the external textual source

is read by a material processing system [103], which could be implemented as a computer software module which imports or loads material such that it can be processed using a natural language comparator [104] and a speech recognition system [105]. The material would then be displayed on a user display [110], which could be a standalone computer monitor, a monitor incorporated into the exercise apparatus [101], a head mounted display worn by the user, or some other device capable of presenting material. According to the intended use of this exemplary implementation, the user would read the material presented on the user display [110] out loud. The user's speech would be detected by a microphone [106], and transformed by a speech recognition system [105] into data which can be compared with the material (e.g., in the case in which the material is composed of computer readable text, the speech recognition system [105] could convert speech detected by a microphone [106] into computer readable text).

In the exemplary implementation, once the user's speech has been converted into data which could be compared with the material read by the material processing system [103], a natural language comparator [104] would perform that comparison [103] to derive data such as current material location (the user's current location in the material), material reading rate (how quickly the user has read the material) and material reading accuracy (correspondence between the user's speech and the material). Such a natural language comparator [104] could use a variety of techniques, and is not intended to be limited any one particular implementation. For example, in deriving the current material location, the natural language comparator [104] could use a character counter (e.g., comparing the number of characters, phonemes, or other units of information spoken by the user with the number of similar units of information in the defined material) to determine what portion of the defined material has been spoken by the user. Alternatively (or potentially for use in combination with a character counter), the natural language comparator [104] could use a forward looking comparative method for determining position (e.g., taking a known or assumed current material location, and comparing a word, phrase, phoneme or other unit of information spoken by the user with words, phrases, or phonemes which follow the assumed or known current material location to find a correct current material location). Of course, the techniques set forth above are not intended to be limiting, and it is contemplated that other techniques could be implemented by those of ordinary skill in the art without undue experimentation in light of this disclosure.

Continuing with the discussion of the exemplary implementation, the data derived by the natural language comparator [104] (potentially in combination with other information) would be sent to a material presentation rate component [107] which could be implemented as a software routine capable of taking input from the natural language comparator [104] (and possibly other sources as well) and determining the optimal rate at which the material should be presented to the user. For example, the material presentation rate component [107] might decrease the material presentation rate if the material reading accuracy provided by the natural language comparator [104] drops below a certain threshold. Alternatively, the material presentation rate component [107] might specify a continuously increasing material presentation rate until the user's material reading speed and/or accuracy falls below a desired level. As yet another alternative, the material presentation rate component [107] could specify that the material should be presented at the same rate as it is being read by the user. Other variations could be implemented without undue experimentation by those of skill in the art in light of this disclosure. Thus, the examples set forth above should be understood as illustrative only, and not limiting.

The material presentation rate would then be provided to a display control component [111] which could be implemented as a software module that instructs the user display [110] how to display material according to specified text presentation format instructions [112]. The format might be optimized for exercise, for example, by indicating word, letter, or line spacing, the number of syllables or words per line, text size or other features which might be manipulated to make the output of the user display [110] more easily perceptible to someone who is exercising (e.g., the spacing between lines could be increased if a user is engaging in an exercise which results in vertical head motion). Similarly, the text presentation format instructions [112] might be customized for individual users so that those users would be better able to perceive the user display [110] while using the exercise apparatus [101]. The display control component [111] uses the text presentation format instructions [112] and the output of the material presentation rate component [107] to cause the user display [110] to advance the material presented (e.g., by scrolling or paging) so that the user could use the exercise apparatus [101] and simultaneously read the material without having to physically effectuate the advance of that material.

In addition to using data derived by the natural language comparator [104] to control the presentation of material on the user display [110], the exemplary implementation of FIG. 1 could also use the exercise apparatus [101] as a source of data, and as a means of providing feedback for the user. For example, the data gathered by the natural language comparator [104] could be provided to an elevation and speed control unit [113] which could modulate the function of the exercise apparatus [101] according to that input. As a concrete example of this, if the data gathered by the natural language comparator [104] indicated that the user's material reading rate was becoming erratic, or that his or her material reading accuracy was falling off (as might result from, for example, fatigue or stress during exercise), the elevation and speed control unit [113] could automatically decrease the speed and/or elevation of the exercise apparatus [101]. A complimentary operation is also possible. That is, in some implementations the speed and/or elevation of the exercise apparatus [101] could be increased until material reading rate and/or accuracy could no longer be maintained at a desired level. Similarly, the function of the exercise apparatus [101] might be controlled continuously by the user's speech. One method of such control would be that, if the user's material reading rate and/or accuracy increase, the speed and/or elevation of the exercise apparatus [101] would increase, while, if the user's material reading rate and/or accuracy decrease, the speed and/or elevation of the exercise apparatus would decrease [101]. Of course, other techniques and variations could be utilized as well, and those set forth herein are intended to be illustrative only, and not limiting. Regarding the potential of the exercise apparatus [101] itself to be used as a source of data, both commands entered by the user on a console [109] to control the exercise apparatus [101] and the output of a physiological measurement devices (e.g., a heart rate monitor [108]) could be used as data which could be combined with the data derived by the natural language comparator [104] to both modulate the intensity of the exercise thought the elevation and speed control unit [113] and to modulate the presentation of material on the user display [110] by using the material presentation rate component [107].

It should be understood that the discussion set forth above, as well as the accompanying FIG. 1, are intended to be illustrative, and not limiting, on the scope of claims included in this application or claiming the benefit of this disclosure. In addition to the information gathering and usage discussed above, the components depicted in FIG. 1 could gather other types of information which could be used, either as an alternative to, or in conjunction with, one or more of the information types described previously. For example, the speech recognition system [105] could be configured to, in addition to transforming the spoken language of the user into computer processable data, gather data regarding that spoken language, such as breathlessness, pronunciation, enunciation, fluidity of speech, or other information which might not be directly determinable from the comparison with the material loaded by the material processing system [103]. Similarly, while the discussion above focused on the use of a treadmill, and the modulation of parameters appropriate to a treadmill (e.g., speed and elevation), other types of exercise apparatus could be used in the exemplary implementation as well. For example, stationary bikes, climbers, wheelchair ergometers, resistance training machines and similar devices could be used as substitutes for the exercise apparatus [101] described above. Further, information could be utilized in different manners, depending on the specifics of an implementation. For example, in some implementations in which the operation of the exercise apparatus [101] is modulated in response to the user's spoken words, the modulation might be performed through messages sent to the user. That is, the display control component [111] might be configured to cause the display [110] to flash messages such as “slow down” to the user, if the user's reading rate and/or accuracy become erratic or decreases below some desired level.

Additionally, instead of an exercise apparatus, the principles described in the context of the exemplary implementation above could be applied to physical activity programs which might not include the use of an exercise apparatus, such as calisthenics, yoga, Pilates, and various floor exercises whether performed alone or in a group led by an instructor who might be live, online, televised, or a computer-controlled or otherwise automated and/or animated virtual coach. Such physical activity programs (or the use of an exercise apparatus) could be coordinated with specially provided material (e.g., an exercise group could be combined with a book club, or such a group or an individual could use material which is serialized to provide an incentive for continued participation) which might be provided by download or through a streaming network source for an additional fee, or might be provided in a medium (e.g., a compact disc) which is included in an up-front participation fee for the user. Similarly, such physical activity programs (or programs utilizing an exercise apparatus) could be coordinate with education programs, for example by using textbooks as the external textual source [102]. Other variations and applications could similarly be implemented without undue experimentation by those of ordinary skill in the art in light of this disclosure. Thus, the examples and discussion provided herein should be understood as illustrative only, and not limiting on the scope of claims included in this applications, or other applications claiming the benefit of this application.

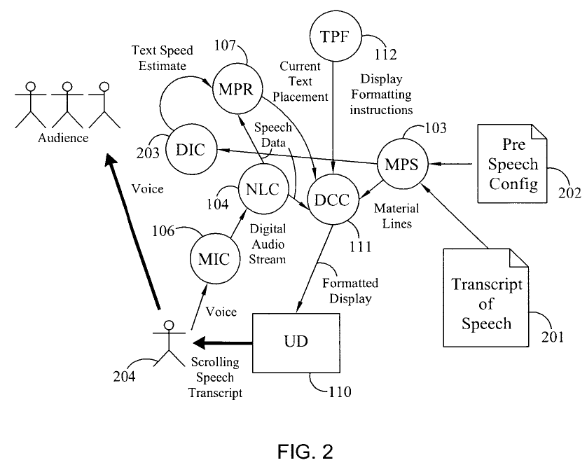

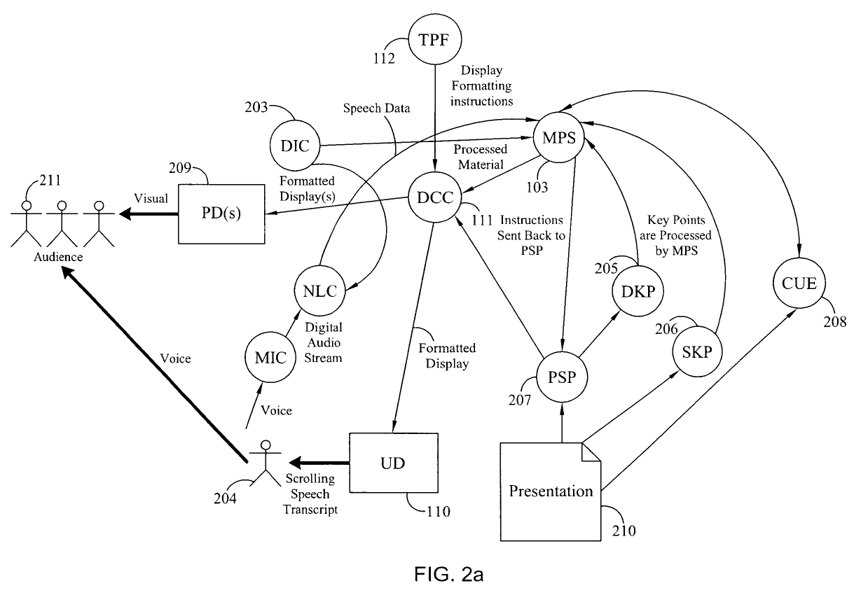

While the discussion of FIG. 1 focused on the use of an exercise apparatus and the potential for implementing a system in which the operation of an exercise apparatus was controlled by a user's reading of material and/or other inputs, the teachings of this disclosure are not limited to being implemented for use with exercise and/or the improvement of physical fitness. For example, referring to FIG. 2, that diagram depicts an application in which the teachings of this disclosure are implemented in the context of presenting material to the public. In FIG. 2, a material processing system [103] reads a transcript of a speech [201] as well as configuration data [202] which is prepared before the speech is to begin. Such configuration data [202] might include a list of key points which the speaker intends to address at certain points in the presentation, and those key points might be correlated to specific portions of the speech transcript [201]. Such key points might be useful to make sure that the presenter does not get ahead of himself or herself, for example, in a presentation where there is audience interaction that could preclude the linear presentation of a speech. This might be done in any number of ways, from presenting a checklist indicating key points which have (and have not) been covered, to establishing dependencies between key points, so that some key points will only be presented on the display when other points which establish background have been covered. Of course, the configuration data [202] is not limited to inclusion of key points. In addition to, or as an alternative to key points, the configuration data [202] might include phonetic depictions of words in the presentation, or instructions which could be used to ensure that the presentation is made in the most effective manner possible. Alternatively, in some instances, the configuration data [202] might be omitted entirely, for example, in a situation in which a presenter [204] will be able to simply read the speech transcript [201] from a display [110] (e.g., a teleprompter, a computer monitor, or any other apparatus capable of making the appropriate content available to the presenter [204]).

Continuing the discussion of FIG. 2, once the configuration data [202] and speech transcript [201] have been read by the material processing system [103], the transcript of the speech [201] (or other information, as indicated by the configuration data [202]) is presented on the display [110] based on an interaction between a display control component [111], a material presentation rate component [107] a dictionary [203], a natural language comparator [104], information captured by a microphone [106], and text presentation format instructions [112]. In that interaction, as was the case with the similar interaction described previously in the context of FIG. 1, the words spoken by the presenter [204] are used as input for the natural language comparator [104] (for the sake of clarity and to avoid cluttering FIG. 2, the speech recognition software [105] depicted in FIG. 1 has not been reproduced in FIG. 2. Such a component might be present in an implementation according to FIG. 2, or might have its functionality included in one or more of the components depicted in that figure, such as the natural language comparator [104]). The natural language comparator provides its output to a material presentation rate component [107] which in turn instructs the display control component [111] as to the optimal rate for presenting material on the display [110]. The display control component [111] takes the information provided by the material presentation rate component [107] and uses that information along with information provided by text presentation formatting instructions [112] to control the information presented on the display [110].

While there are some similarities between the function of the implementation in the context of an exercise apparatus described with reference to FIG. 1, and the implementation in the context of public presentations depicted in FIG. 2, there are also certain differences which should be noted. For example, the implementation depicted in FIG. 2 includes a dictionary component [203], which is a component that can be used to determine how much time a word should take to say (e.g., by including a word to syllable breakdown with time/syllable information, by including direct word to time information, by including information about time for different phonemes or time for different types of emphasis, or other types of temporal conversion information as appropriate to a particular context). The output of the dictionary component [203] could be used by the material presentation rate component [107] to arrive at an optimal material presentation rate for the speech. Similarly, in the diagram of FIG. 2, the components which are common with the diagram of FIG. 1 might be differently optimized or configured for the context of speech presentation or preparation. For example, in the diagram of FIG. 2, the display control component [111] might include instructions for the display [110] based on key point information, which could be provided by the material processing system [103], and then examined against the output of the natural language comparator [104] (or against the output of speech recognition software [105], not pictured in FIG. 2). Similarly, while in FIG. 1 the text presentation format instructions [112] were discussed in terms of optimization for perception of information while exercising, for an implementation such as FIG. 2 the text presentation format instructions [112] might be optimized for the perception of information to be read from a distance (e.g., from a teleprompter). Such optimization might include parameters such as words, letters or phonemes which should be displayed within a given number of pixels, lines, or other unit of distance. Alternatively, the same optimizations discussed with respect to FIG. 1 could also be applied to the implementation of FIG. 2. Similarly, the same components used in FIG. 2 (e.g., the dictionary [203]) could be incorporated into a system such as shown in FIG. 1. Regardless, the implementations of FIG. 1 and FIG. 2 are intended to be flexible enough that a variety of optimizations and configurations could be used within the context of those figures.

As an example of a further variation which could be used in the context of presenting material to an audience, consider the diagram of FIG. 2a. In FIG. 2a, a presentation is given with the aid of some third party presentation software package [207], such as open source products including Impress, KPresenter, MagicPoint or Pointless, or proprietary programs such as PowerPoint, or other software application capable of being used to create sequences of words, pictures and/or media elements that tell a story or help support a speech or public presentation of information. In FIG. 2a, rather than utilizing the multiple information source format set forth in FIG. 2 (i.e., a format in which the transcript of the speech [201] is separate from the configuration data [202]), the implementation of FIG. 2a depicts a configuration in which there is a single source for presentation information [210]. The presentation information [210] includes a list of static key points [206], which are words or phrases which can act as indicators of key points in the presentation given by presenter [204]. The presentation information [210] also includes a list of cue data [208] which can be used to trigger the execution of functionality (e.g., multimedia displays), programs (e.g., mini-surveys which might be given to incite participation or increase interest level during the presentation), and/or any other functionality. The speech as given by the presenter [204] could then be used to coordinate spoken words with external effects (e.g., multimedia presentations), which could allow for greater flexibility in information presentation than would otherwise be possible without the cue data [208].

FIG. 2a also depicts additional functionality and equipment which were not shown in FIG. 2. For example, the diagram of FIG. 2a includes a public display [209], which could be a cathode ray tube, flat screen monitor, series of individual television or computer screens, one or more projector screens, or any other device which is operable to present material to be viewed by members of an audience in conjunction with the speech given by the presenter [204]. It should be understood that, while the material presented on the public display [209] can be presented in conjunction with the speech given by the presenter [204], the material on the public display [209] does not necessarily correspond with the material presented on the user display [110] which is seen by the presenter [204] himself or herself. For example, the material presented on the user display [110] might be a terse subset of the presentation information [210] designed to enable the presenter

to remember what points in the presentation have already been covered, while the material on the public display [209] might include visual aids, an automatic transcription of the presenter's speech, or any other information which could be appropriately provided to an audience [211]. Additionally, the diagram of FIG. 2a includes a dynamic key points component [205] which could be used to determine that key points have been addressed by dynamically comparing the speech given by the presenter [204] with a predefined list of key points. This dynamic key points component [205] might function by analyzing the semantic content of the speech as given by the presenter [204] (e.g., by using thesaurus and semantic lookup capabilities) to automatically determine if speaker [204] has addressed a key point in the presentation. The semantic analysis could be used as an alternative to the predefined words or phrases mentioned previously in the context of the static key points [206]. As a further alternative, and as shown in FIG. 2a, both dynamic [205] and static key points [206] could be used simultaneously, or the potential to use both sets of functionality could be present in a single system, providing discretion to the user as to what should be incorporated or utilized in a single presentation.

As set forth above and shown by the examples of FIGS. 1, 2 and 2a, the operation of external devices (e.g., the exercise apparatus discussed in the context of FIG. 1) and the presentation of material (e.g., the speech transcript and presentation information discussed in the context of FIGS. 2 and 2a) can be advantageously coordinated with an individual's spoken words, and/or other data. However, it should be understood that, while the above discussion has highlighted certain ways in which the teachings of this disclosure can be implemented, and described features which may be present in those implementations, the implementations discussed herein should not be treated as limiting on the teachings of this disclosure. For instance, aspects of this disclosure could be implemented in the fields of neurophysiologic stimulation and evaluation, game playing statistical data gathering, machine learning, and many other areas. As a demonstration of this variability, certain implementations in these other areas are set forth below. As with the discussion set forth previously, the implementations set forth below are intended to be illustrative only, and not limiting on the scope of claims which are included in this application or which claim the benefit of this disclosure.

In the field of interactive gaming, the output of a natural language comparator could be used to drive the progress of a user in a game, to speed learning and retention of academic materials, to improve speaking and/or reading skills, along with other uses which could be implemented by those of ordinary skill in the art without undue experimentation in light of this disclosure. For example, a portion of the teachings of this disclosure could be implemented in a computer game in which control of the game is accomplished, either in whole or in part, by the use of a comparison of words spoken by the player with material presented on a screen. The game itself might be structured such that the complexity of material presented might increase as play progresses. For instance, the game might be organized into levels, with material presented on a first level being of a generally low difficulty level (e.g., simple vocabulary, short sentences, passages presented without dependent clauses or other complex grammatical constructions, etc), while material on a second and subsequent levels increases in difficulty. The player's progress from one level to the next might be conditioned upon the user's correctly reading the material presented at a first level, thereby providing an incentive for the player to improve his or her reading skills. As an alternative, in a game in which content is organized into levels, progress from one level to another might depend on statistics regarding the player's ability to read material presented. For example, a natural language comparator might measure material reading accuracy, and the game might only allow the user to progress from one level to the next when the user's material reading accuracy exceeds a certain threshold (e.g., 80% accuracy for the material read during a level). Similarly, the natural language comparator might measure material reading rate information, and the game might allow a user to proceed from one level to another based on whether the user is able to maintain a given reading rate. Of course, other statistics, or even overall performance measures, such as a game score, might be used to determine progress in a game, and the use of individual statistics and performance measurements might be combined. Similarly, the progression between levels might follow a non-linear, or non-deterministic path (e.g., there might be multiple possible progressions, with the actual path taken by the user being determined based on performance during the level, randomly, or as a combination of factors).

In addition to enabling computer games with both linear and non-linear level progressions, the teachings of this disclosure could be used in computer games which are not structured according to the level progression described previously. For example, even if levels are not used, an implementation could provide motivation for reading material by presenting paragraphs of continuous reading material (e.g., simple poems with images) as rewards for successful reading (e.g. reading material at a desired rate and/or accuracy, thoroughly reading material at a determined level of complexity, or other measurement of successful reading). Similarly, a game could provide a user with higher scores, as well as more opportunities to score, based on information gathered regarding the user's ability to read material presented on a screen (e.g., material reading rate, material reading accuracy). Such a score might also be combined with a threshold function (e.g., the user must maintain at least a minimal reading rate and/or accuracy in order to score points) so as to provide appropriate incentives for the user during game play. There might also be various measuring algorithms incorporated into a natural language comparator. For example, there might be a phonetic dictionary incorporated into the natural language comparator (or made available as an outside module) which could be used to determine the correctness of a player's pronunciation and emphasis. That information could then be applied as discussed previously with respect to material reading rate and material reading accuracy. Such computer games (including the natural language comparators, dictionaries, and other material) might be encoded on a disc or cartridge, and then played using a home gaming console, such as a Playstation, XBOX, or Game Cube. They might be sold alone, bundled with a game console, or bundled with peripherals, such as a microphone or other input device. Alternatively, they could be played using a personal computer, or with dedicated hardware (e.g., an arcade console). Such media and configurations are presented for illustration only, and should not be interpreted as limiting on the scope of any claims included in this application or which claim the benefit of this disclosure.

As a technique for maximizing the beneficial effects of utilizing a natural language comparator in an interactive gaming application, some implementations could be designed for optimization by a teacher, parent, or other individual who wishes to encourage learning. For example, in some interactive gaming applications, the text presentation format instructions might be varied or altered in order to provide a benefit to the user (e.g., the system might decrease font size and/or word spacing until reading speed peaks, or might optimize the text presentation format instructions to match the user's estimated reading level or the complexity of the material presented to the user). While such alterations might be pre-programmed, it is also possible that the interactive gaming application might allow a teacher or other educator to configure the text presentation instructions to maximize the benefit to the individual user (e.g., by assigning text presentation instructions to match the user's reading skill level). Similar customization by a teacher or other educator could be performed by selecting particular material (e.g., a subject matter which a user is particularly interested in, or a subject matter for which a user requires remediation), or by varying other aspects of the interactive gaming application.

As set forth previously, the teachings of this disclosure can be implemented to gather data regarding an individual's ability to read material or their spoken words. For example, a system in which material is presented to a reader, and the words spoken by the reader are compared in real time with the text of the material presented could be used to test reading ability while avoiding the need for close supervision of the reader or self reporting to determine if a passage has been fully read. Measurements obtained during reading could be stored to track an individual's progress (e.g., change in reading accuracy over time, change in reading rate over time) and could potentially be combined with tests of reading comprehension already in use (e.g., to determine a relationship between reading accuracy and material comprehension, or between reading rate and material comprehension). Further, in addition to gathering data which directly reflects on an individual's reading aloud, the teachings of this disclosure could be implemented for use in gathering data which is indicative of other information. For example, statistical data gathering could be combined with use of an exercise apparatus to determine what level of physical effort a user is able to exert without compromising their ability to read or speak clearly. Such a determination could be used for evaluating capabilities of individuals who must read and/or speak while under exercise and metabolic stress such as military, police and fire personnel. Additionally, the objective information obtained by the natural language comparator could be used as the basis for quantitative assessment of limitation or disability caused by dyslexia and similar complexes, or by disease, accident or other factors affecting visual acuity, or cognitive capacity. Such statistical data could then be maintained using a metric storage system which could store the collected data in some form of storage (e.g., stable storage such as a hard disk, or volatile storage such as random access memory), thereby allowing comparison of various measurements and detection of trends over time.

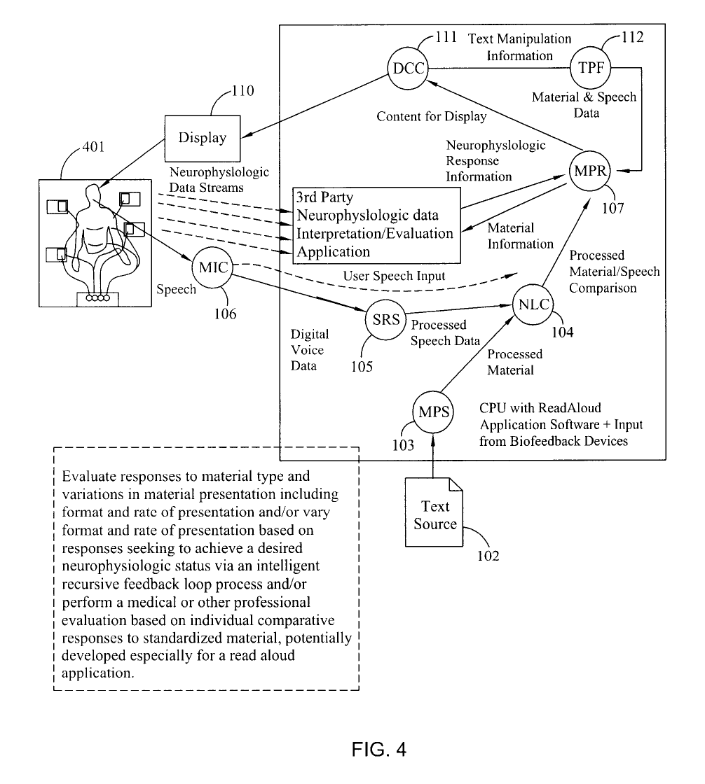

Yet another area in which the teachings of this disclosure could be implemented is in the achievement of desired neurophysiologic states and brain activity levels. As was discussed previously in the context of FIG. 1, information obtained from physiology monitoring devices (e.g., a heart rate monitor) while an individual is exercising and reading aloud can be used to modulate the presentation of material the user is reading, and the intensity of the exercise performed by the user. However, using physiological information in combination with speech information is not limited to the context of exercising. For example, turning to FIG. 4, that figure depicts certain data flows which might be found in a system which uses a comparison of a user's speech with information from a text source [102] along with information regarding a user undergoing neurophysiologic monitoring [401] to achieve a desired state for the user, or to evaluate the user's neurophysiologic responses to material being read. In a system such as that displayed in FIG. 4, the operation of the material presentation rate component [107] and the text presentation format instructions [112] might be modulated based on feedback such as neurophysiologic response information and the output of the natural language comparator [104] in order to attain an optimal neurophysiologic state. As a concrete example, if a system such as depicted in FIG. 4 is used to measure and optimize brain blood flow (a commonly used indicator of brain activity), the material could be presented a rate and in a format which allows a user to devote maximum attention to reading, rather than in a format which is hard to read, or a rate which is hard for the user to follow, thus leading to frustration and potential loss of interest by the user.

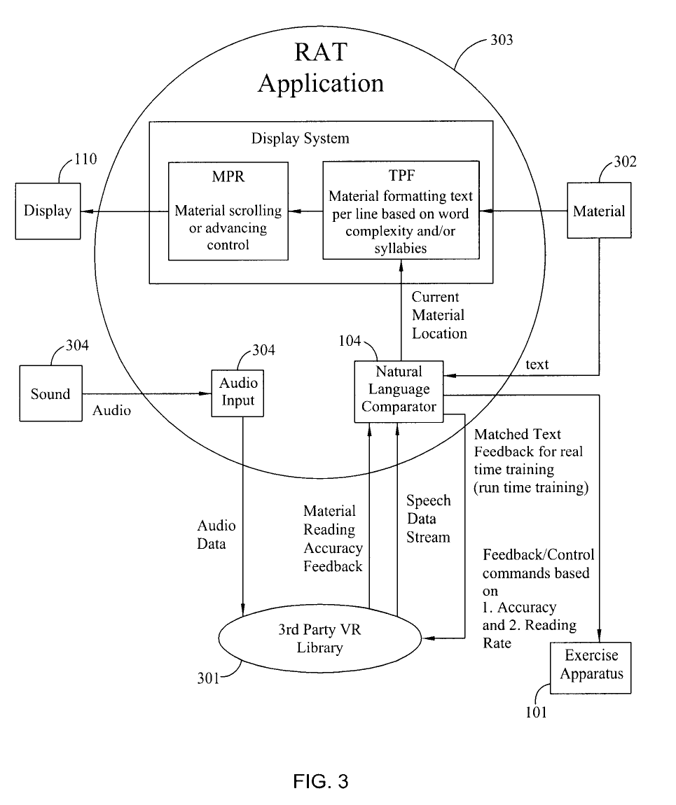

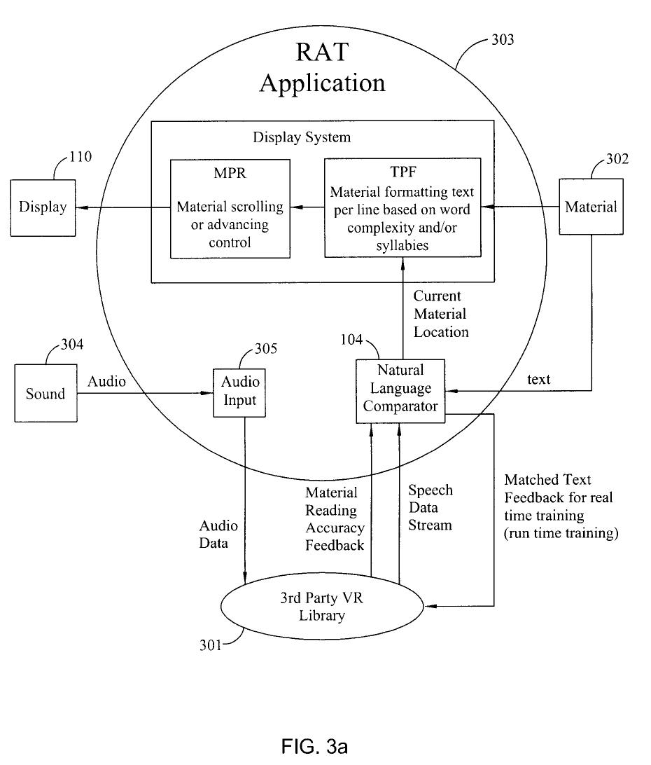

Another potential application of the teachings of this disclosure is in the area of machine learning as used in the training of voice recognition software. As an example of this, FIG. 3 depicts how third party voice recognition software [301] could be trained, in real time, during the operation of an exercise apparatus [101] which is controlled in part based on a comparison of a user's speech with some defined material [302] (e.g., text, such as text with embedded graphics, or graphics with embedded text, symbolic pictures, or some other material which could be displayed to the user and compared with the user's spoken words). In FIG. 3, the defined material [302] is read into a read aloud technology (RAT) application [303]. In FIG. 3, the RAT application [303] causes the material to be presented on a display [110], which is then read by a user to produce sound [304] which is detected by an audio input [305] (e.g., a microphone) that sends the sound as audio data to a third party voice recognition (VR) library [301]. The third party VR library [301] then sends its transcription of the user's speech to the RAT Application [303] (e.g., as a speech data stream). The third party VR library [301] might also send an indication of its confidence in the accuracy of the transcription to the RAT application [303] (e.g., as material reading accuracy feedback). The RAT application [303] might then use the natural language comparator [104] to compare the transcription provided by the third party VR library [301] with the predefined material [302] to determine the portion of the material [302] being read by the user. The RAT application [303] could then provide the appropriate portion of the material [302] to the third party VR library [301] as an indication of what a correct transcription should have been, so that the third party VR library [301] can be trained to more accurately transcribe the speaker's words in the future. Thus, the often frustrating and time consuming task of training a speech recognition system could be combined with the productive and beneficial activity of exercising. Of course, it should be realized that the use of a RAT application [303] for training a third party VR library [301] is not limited to situations wherein a user is concurrently using an exercise apparatus [101]. For example, FIG. 3a depicts a system in which a RAT application [303] is used to train a third party VR library [301] without the simultaneous use of an exercise apparatus [101].

The teachings of this disclosure could be used to facilitate other types of machine learning as well. For example, as set forth previously, text presentation format instructions could be optimized for various tasks (e.g., larger text for incorporation into a teleprompter application to facilitate reading at a distance). Using the teachings of this disclosure, it is possible to use the comparison of a user's speech with predefined material for dynamically learning the optimal presentation format instructions for a particular user, or even for a particular application. This could be accomplished by tying various parameters of the text presentation format instructions (e.g., font size, lines/page, words/line, characters/line, syllables/line, font style, character contrast, highlighting, etc.) to the output of a natural language comparator which can determine statistics such as material reading accuracy and material reading rate. The parameters of the text presentation format instructions could then be varied, for example, according to trial and error, feedback loop, or other methodologies to find optimal parameter combinations. For example, the font size could be decreased, or the number of lines per page could be increased until they reach values which simultaneously allow the greatest amount of material to be presented on a display during a given period of time without compromising the rate and accuracy of the user's reading. Certain applications of this type of machine learning for the optimization of text presentation format instructions are set forth below. It should be understood that the applications set forth below are intended to be illustrative only, and not limiting on the scope of claims included in this application, or claims of other applications claiming the benefit of this application.

One application for optimization of text presentation format instructions is in preparation for presentations in which the presenter will be accompanied by potentially distracting effects (e.g., changes is lighting, inception of related audio material or multimedia clips, etc). For such a use, the presenter could practice the presentation, and the text presentation format instructions could be optimized for the various conditions which would be present in the presentation (e.g., the text presentation format instructions could be configured with respect to the time or content of the presentation so that, coincident with a dramatic change in lighting, the text presentation format instructions would instruct that the material displayed to the presenter be presented in a large, easy to read font, with highlighting, so that the presenter would not lose his or her place in the material). This might be accomplished, for example, by recording the presenter's ability to make the presentation with a default set of text presentation format instructions, then configuring the text presentation format instructions so that the text displayed for the presenter would be made easier to read during portions of the presentation where the presenter's material reading rate and/or material reading accuracy decrease or become erratic. Of course, other techniques for automatic optimization could also be used, or text presentation format instructions could be manually determined, for example, by the user specifying that the brightness of material presented on a display should be increased during a portion of presentation in which there will be little or no illumination. Thus, the discussion of machine learning in the context of optimizing text presentation format instructions for a presentation should be understood as illustrative only, and not limiting.

Another use which could be made of the application of the teachings of this disclosure to machine learning is to enable material to be presented in a manner which is optimized for vision impaired individuals. For example, for individuals who have some form of progressive vision loss (e.g., macular degeneration), text presentation format instructions could be modified so that the text would be presented in a way which takes into account the individual's impairment (e.g., the text could be magnified, or, in the case of macular degeneration, the spacing between lines, characters, and/or words could be adjusted, perhaps even on a differential basis for different regions of a display, to help compensate for loss of the central visual field, or differing fonts could be used, such as elongated fonts, or serif fonts having visual clues for simplifying reading, such as Times Roman, or Garamond). This modification could happen through techniques such initially presenting material to a user in a font and with a magnification (e.g., high magnification, serif font) which makes it easy to read the material, and then progressively modifying the magnification and other parameters (e.g., spacing between lines, font elongation, spacing between words, etc) to find a set of text presentation format instructions which allow that user to read at a desired level of accuracy and speed without requiring unnecessary use of magnification or other measures which might be appropriate for more severely impaired individuals. Alternatively, such a system might use initially more obscure text presentation format instructions (e.g., no magnification, small spacing between lines, etc) and modify the display of text in the opposite manner. Other modifications and variations will be apparent to those of skill in the art in light of this disclosure. Of course, it should be understood that it is not necessary to use machine learning for text presentation format instructions to take into account an individual's disability. For example, similar effects could be obtained through the use of predefined text format instructions which are specifically designed for individuals with particular impairments. Thus, this discussion of machine learning and vision impairment should be understood to be illustrative only, and not limiting on the scope of the claims included in this application, or in any applications claiming the benefit of this application.

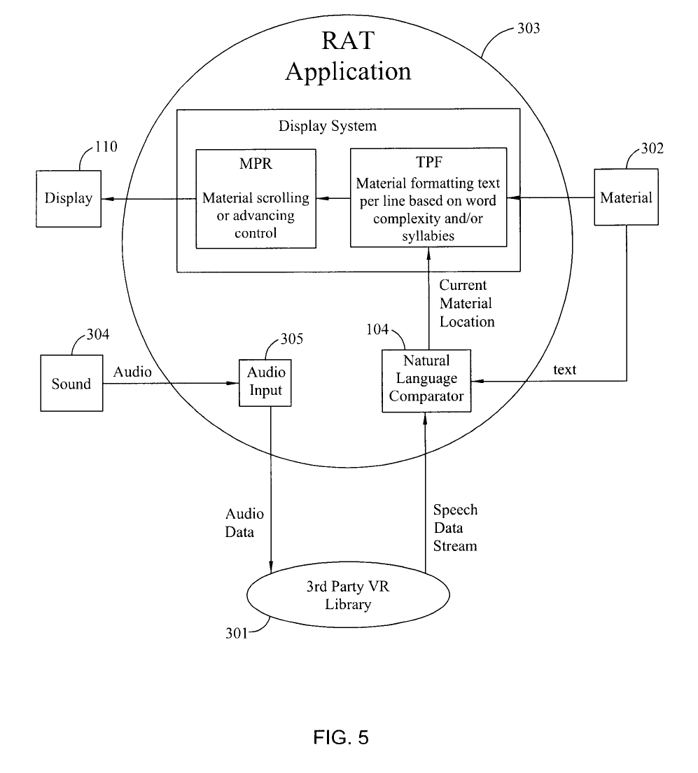

Additionally, while this disclosure has indicated how comparison of a user's spoken words with predefined material can facilitate the performance of activities in addition to reading (e.g., exercising, game playing), the teachings of this disclosure could also be applied in the context of improving the convenience of the activity of reading itself. For example, a comparison and feedback loop as described previously could be applied to devices which can be used by individuals who might have a physical impairment which eliminates or interferes with their ability to turn the pages of a book. Similarly, a computer program or standalone device which incorporates a comparison of spoken words with defined material could be sold to individuals who wish to combine reading with hobbies or activities of their own choosing which might interfere with turning pages, such as knitting, woodworking, reading a recipe during food preparation, reading instructions while performing assembly or troubleshooting tasks, or washing dishes. The comparison of an individual's spoken words with predefined material, and the control of a display based on that comparison might be used in other manners to facilitate the process of reading as well. For example, material presented on a display might be highlighted to indicate a user's current material location, which could help the user avoid losing their place or becoming disoriented by discontinuities in reading, such as might be introduced by paging material on the display, or by external interruptions (e.g., phone calls, pets, etc). An example of how such a system for facilitating reading while performing other tasks might be implemented is set forth in FIG. 5. It should be understood, of course, that the system of FIG. 5 could be used in combination with other components, as opposed to being limited to being used as a stand-alone system. For example, a system comprising a computer, and a web browser could be augmented with a RAT application [303] (perhaps embodied as a plug in to the web browser) which would allow the web browser to be controlled by data including a comparison of material available on the internet (e.g., web pages) with a user's speech. Such a system, comprising a web browser, computer and RAT application [303] could allow a user to control the presentation of web pages by reading aloud the content of those web pages. For example, the user could control which stories from a news web site would be displayed by reading aloud the text of those stories, rather than forcing the user to rely on navigation methods such as hyperlinks. Additional applications and combinations of the components of FIG. 5 with other components and applications could be implemented by those of ordinary skill in the art in light of this disclosure without undue experimentation. Thus, the discussion of FIG. 5 should be understood as illustrative only, and not limiting on the claims included in this application or included in other applications claiming the benefit of this application.

More specialized applications of a comparison of spoken words with predefined material are also possible. For example, a system such as that depicted in FIG. 1 could be used in a specialized program for the elderly to help delay or prevent various types of age related mental decline, dementias and similar disability resulting from many causes including Alzheimer's disease. Many experts believe that physical activity which increases brain blood flow and oxygenation can promote the rapid growth of new blood vessels and decrease the formation of dangerous amyloid plaques associated with dementia. A system such as depicted in FIG. 1 could be used to help individuals at risk for age related mental decline engage in two activities (reading aloud and exercise) which increase brain blood flow and thereby reduce the risk and/or effects of age related mental decline. As a second example of a specialized application for the teachings of this disclosure, consider an application in which a user's speech must be recognized, and it is approximately known what a user will say, but not known when or how the user will say it. In such an application, by applying the teachings of this disclosure, a relatively inaccurate (and therefore generally less expensive) speech recognition engine could be used to obtain a tentative recognition of the speech of a user, which tentative recognition could then be provided to a natural language comparator which could, for example by using forward looking comparison, determine the user's current material location, and provide a “recognition” of the user's speech taken from the defined material it is expected that the user will speak (i.e., read aloud). Of course, these exemplary applications are not intended to be limiting, and alternative uses could e made by those of ordinary skill in the art without undue experimentation.

As yet another example of specialized applications of certain of the techniques described herein, it is also possible that a standalone device, such as an electronic book, could be used to help define text presentation format preferences for a particular individual. For instance, using the text presentation format optimization techniques described above, a standalone device could be used to determine the text presentation format (e.g., characters per line displayed, character spacing, and spacing between lines) which allows an individual to maximize his or her reading rate (e.g., as indicated by material presentation rate for the user). Those optimized text presentation format instructions could then be stored as user preferences which could be used as default text presentation format instructions on the standalone device. The optimized text presentation format instructions could also be stored on a removable memory device (e.g., a flash drive) or communicated over a network, so that other Read Aloud enabled devices or similar devices which could be used to display material based on user preferences could use those optimized text presentation format instructions without requiring the user to repeat the process of optimization, thereby allowing the user to automatically create a distinctive display, for the purpose of matching the user's creative preferences, visual abilities, reading needs, or for other reasons. Of course, it should be understood that the above described application is not intended to indicate limitations on potential techniques for personalization of text presentation format instructions. For example, in some implementations, text presentation format instructions could be manually optimized (e.g., by a user selecting preferences) and then stored and used at a later time as described above. As an additional alternative, it is possible that text presentation format preferences could be used for purposes other than maximizing reading speed, such as decreasing eyestrain or finding appropriate accommodations for visually impaired individuals, further, characteristics of text other than simply characters per line displayed and spacing between lines (e.g., font type, font size, bold/underline or other formatting choices, background color/shading, text color/shading, etc.) could also be determined and stored as preferences using techniques such as described above. Further variations could also be implemented by those of ordinary skill in the art without undue experimentation in light of this disclosure. Accordingly, the above description should be understood to be illustrative only, and not limiting.

The preceding paragraphs have set forth examples and implementations showing how the teachings of this disclosure can be applied in various contexts. The preceding paragraphs are not intended to be an exhaustive recitation of all potential applications for the teachings of this disclosure. It should be understood that the inventors contemplate that the different components and functions set forth in this disclosure can be combined with one another, and with other components and functions which could be implemented by one of skill in the art without undue experimentations. For example, the statistical measurement and record keeping functions discussed in the context of game playing and testing could be incorporated into the contexts of exercise (e.g., a workout diary), neurophysiologic stimulation (e.g., medical progress reports), and presenting material to an audience (e.g., a rate and style log allowing the speaker to replicate successful performances and to quickly see how presentations change over time). Therefore, the inventor's invention should be understood to include all systems, methods, apparatuses, and other applications which fall within the scope of the claims included in this application, or any future applications which claim the benefit of this application, and their equivalents.

What is claimed is:

1. A device comprising:
a) a microphone operable to detect speech;
b) a display operable to display material from a defined source, wherein said display is based at least in part on a set of text presentation format instructions;
c) a natural language comparator operable to compare speech detected by the microphone with material from the defined source; and
d) a computer readable medium having stored thereon a set of computer executable instructions configured to:
i) modify said set of text presentation format instructions based at least in part on an output from the natural language comparator; and
ii) store said set of text presentation format instructions as a user preference.

2. The device of claim 1 wherein said set of computer executable instructions are configured to modify said set of text presentation format instructions to maximize a reading speed of a user.

3. The device of claim 1 further comprising a device port, wherein said set of computer executable instructions are operable to store said set of text presentation format instructions on a second device via said device port.

4. An apparatus comprising:
a) a natural language comparator operable to derive a plurality of measurements regarding a user's speech input based on a comparison of the user's speech input with a text string obtained from a defined material source;
b) a display control component operable to determine an image for presentation on a display based on one or more of the measurements derived by the natural language comparator;
c) a metric storage system operable to store a set of performance data based on the user's speech input.

5. The apparatus as claimed in claim 4 wherein the defined material source comprises a set of narrative data which is organized into a plurality of levels; and wherein presentation of narrative data corresponding to a first level from the plurality of levels is conditioned upon a measurement from the set of performance data reaching a defined threshold.

6. The apparatus as claimed in claim 5 wherein the measurement is stored on a first computer readable medium and wherein the metric storage system, the display control component, and the natural language comparator are encoded as instructions stored on a second computer readable medium.

7. The apparatus as claimed in claim 4 wherein the set of performance data comprises:
a) reading accuracy; and
b) reading rate
and wherein the image comprises a portion of the text string.

8. The apparatus as claimed in claim 4 wherein the apparatus is operable in conjunction with a home video game console.

9. The apparatus as claimed in claim 4 wherein the natural language comparator is operable to derive information indicating correct reading of a passage presented on the display and wherein, as a result of the natural language comparator indicating correct reading of the passage, the display control component determines that a second passage should be presented on the display, and wherein the second passage provides positive reinforcement for the correct reading of the first passage.
